(19) United States
(12) Patent Application Publication
(10) Pub. No.: US 2023/0387830 A1
(43) Pub. Date: Nov. 30, 2023

(54) ULTRASONIC MOTOR

(71) Applicant: Murata Manufacturing Co., Ltd., Nagaokakyo-shi (JP)

(72) Inventor: Hiroshi ASANO, Nagaokakyo-shi (JP)

(21) Appl. No.: 18/450,121

(22) Filed: Aug. 15, 2023

Related U.S. Application Data
(63) Continuation of application No. PCT/JP2022/014301, filed on Mar. 25, 2022.

(30) Foreign Application Priority Data
Apr. 12, 2021 (JP) 2021-066982

(51) Int. Cl. H02N 2/10; H02N 2/12

(52) U.S. Cl. CPC H02N 2/103; H02N 2/12

(57) ABSTRACT

An ultrasonic motor is provided that includes a stator having a plate-shaped vibrating body with first and second opposing main surfaces and a through-hole penetrating in a direction in which the first and second main surfaces face each other, and a piezoelectric element on the first main surface. Moreover, a stator fixing member is provided having a rotor in contact with the second main surface, a main body portion is disposed on the first main surface side, and a whirl-stop portion extends from the main body portion toward the vibrating body side. The whirl-stop portion and the through-hole of the stator have a polygonal shape in a plan view. The number of vertices of the whirl-stop portion and the through-hole is the same, and the whirl-stop portion and the through-hole are fitted to each other.

### CROSS REFERENCE TO RELATED APPLICATIONS

This application is a continuation of International Application No. PCT/JP2022/014301, filed Mar. 25, 2022, which claims priority to Japanese Patent Application No. 2021-066982, filed Apr. 12, 2021, the entire contents of each of which are hereby incorporated by reference in their entirety.

### TECHNICAL FIELD

The present invention relates to an ultrasonic motor.

### BACKGROUND

Conventionally, there have been proposed various ultrasonic motors, in each of which a stator is vibrated by a piezoelectric element. For example, Japanese Patent Application Laid-Open No. 10-248273 (hereinafter “Patent Document 1”) discloses an example of an ultrasonic motor. In this ultrasonic motor, a moving body is rotated by a standing wave generated in a vibrating body. The moving body is disposed on one main surface side of the vibrating body, and a vibrating body fixture is disposed on another main surface side. Moreover, the vibrating body is provided with a small hole through which a rotation shaft of the moving body is inserted. The vibrating body fixture fixes the main surface of the vibrating body around the small hole and at a node of vibration of the vibrating body.

In operation, a vibrating body receives a reaction force from a rotor side when applying a force to rotate a moving body, that is, the rotor. Therefore, it is necessary to firmly fix the vibrating body in order to prevent the vibrating body from rotating due to the reaction force. In the ultrasonic motor described in Patent Document 1, the vibrating body is fixed also around a small hole. Since a portion around the small hole in the vibrating body vibrates, if such a portion is firmly fixed, a vibration of the vibrating body is inhibited. Therefore, the performance of the ultrasonic motor may be deteriorated.

### SUMMARY OF THE INVENTION

Therefore, it is an object of the present invention to provide an ultrasonic motor that effectively fixes a vibrating body and minimizes inhibiting a vibration of the vibrating body.

In an exemplary aspect, an ultrasonic motor is provided that includes a stator having a plate-shaped vibrating body including a first main surface and a second main surface facing each other and a through-hole penetrating in a direction in which the first main surface and the second main surface face each other. The stator further includes a piezoelectric element on the first main surface of the vibrating body. The motor further includes a stator fixing member having a rotor in contact with the second main surface of the vibrating body, a main body portion disposed on the first main surface side of the vibrating body, and a stator fixing member having a whirl-stop portion extending from the main body portion to the vibrating body side, in which the whirl-stop portion of the stator fixing member and the through-hole of the stator have a polygonal shape in the plan view, the number of vertices of the whirl-stop portion and the through-hole is the same, and the whirl-stop portion and the through-hole are fitted to each other.

According to the ultrasonic motor of the exemplary aspect, the vibrating body can be effectively fixed, and the vibration of the vibrating body is hardly inhibited.

### BRIEF DESCRIPTION OF DRAWINGS

FIG. 1 is a front sectional view of an ultrasonic motor according to a first exemplary embodiment.

FIG. 2 is an exploded perspective view of the ultrasonic motor according to the first exemplary embodiment.

FIG. 3 is a plan view illustrating the vicinity of a whirl-stop portion and a first protruding portion of a stator fixing member according to the first exemplary embodiment.

FIG. 4 is a plan view illustrating a through-hole of a vibrating body and the vicinity of the whirl-stop portion of the stator fixing member according to the first exemplary embodiment.

FIG. 5 is a bottom view of a stator according to the first exemplary embodiment.

FIG. 6 is a front sectional view of a first piezoelectric element according to the first exemplary embodiment.

FIG. 7 is a schematic diagram for explaining each vibration mode.

FIGS. 8(a) to 8(c) are schematic bottom views of the stator for explaining a traveling wave excited in the first exemplary embodiment.

FIG. 9 is a bottom view for explaining a relationship between a shape of a through-hole and a position of a piezoelectric element in the stator according to the first exemplary embodiment.

FIG. 10 is a bottom view for explaining the relationship between the shape of the through-hole and the position of the piezoelectric element in the stator of a second exemplary embodiment.

### DETAILED DESCRIPTION

Hereinafter, the present invention will be clarified by describing specific exemplary embodiments with reference to the drawings.

Note that each of the embodiments described in the present description is an exemplary embodiment, and replacement of some part or combination of configurations is possible among different embodiments.

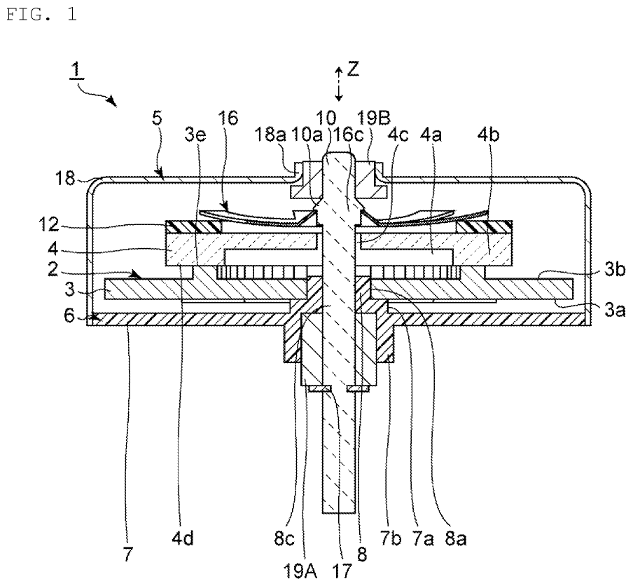

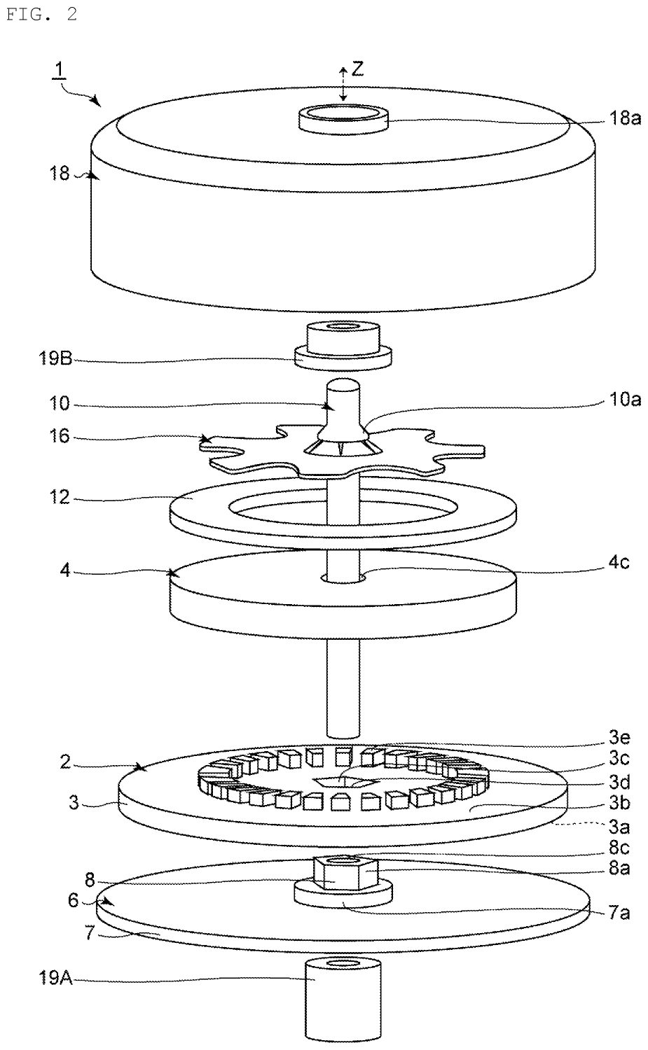

FIG. 1 is a front sectional view of an ultrasonic motor according to the first exemplary embodiment. FIG. 2 is an exploded perspective view of the ultrasonic motor according to the first exemplary embodiment.

As illustrated in FIG. 1, the ultrasonic motor 1 has a stator 2, a rotor 4, a case 5, and a shaft member 10 (also referred to simply as a shaft). The case 5 houses the stator 2 and the rotor 4. It is noted that the case 5 is configured with a stator fixing member 6 as a first case member and a cap member 18 as a second case member. The stator 2 and the rotor 4 are in contact with each other. The rotor 4 is rotated by a traveling wave generated in the stator 2. On the other hand, the shaft member 10 is inserted through the stator 2 and the rotor 4 and reaches the outside of the case 5. As the rotor 4 rotates, the shaft member 10 rotates. However, the rotor 4 may include the shaft member 10 in another exemplary aspect. Hereinafter, a specific configuration of the ultrasonic motor 1 will be described.

As illustrated in FIG. 2, the stator 2 has a vibrating body 3 that has a disk shape. The vibrating body 3 has a first main surface 3a and a second main surface 3b that face each other. For purposes of this disclosure, an axial direction Z is a direction along which the first main surface 3a and the second main surface 3b are connected, and is a direction along a rotation center. The shaft member 10 extends in parallel with the axial direction Z. Moreover, a direction viewed from the axial direction Z is referred to as a plan view or a bottom view in some cases. It is noted that the plan view is a direction viewed from above in FIG. 1, and the bottom view is a direction viewed from below. For example, a direction viewed from the second main surface 3b side to the first main surface 3a side of the vibrating body 3 is a plan view, and a direction viewed from the first main surface 3a side to the second main surface 3b side is a bottom view.

As further shown, a through-hole 3c is provided in a central portion of the vibrating body 3 that has an inner side surface 3d facing the through-hole 3c. In a plan view, the through-hole 3c has a regular pentagonal shape. That is, the shape of the through-hole 3c in the plan view is a regular pentagon. However, the position and shape of the through-hole 3c are not limited to the above. The through-hole 3c only needs to be located in a region including an axial direction center. The shape of the through-hole 3c in the plan view may be, for example, a polygon other than a pentagon. The through-hole 3c preferably has a regular polygon shape in the plan view. Furthermore, the shape of the vibrating body 3 is not limited to a disk shape. For example, the shape of the vibrating body 3 in the plan view may be a regular polygon, such as a regular hexagon, a regular octagon, or a regular decagon in alternative aspects. The vibrating body 3 is made of an appropriate metal, but may not necessarily be made of a metal. For example, the vibrating body 3 may be configured with another elastic body such as a ceramic, a silicon material, or a synthetic resin.

As illustrated in FIG. 1, a plurality of piezoelectric elements is provided on the first main surface 3a of the vibrating body 3. In operation, the plurality of piezoelectric elements vibrate the vibrating body 3 to generate a traveling wave.

The rotor 4 is in contact with the second main surface 3b of the vibrating body 3. The rotor 4 has a disk shape. A through-hole 4c is provided in a central portion of the rotor 4. However, the position of the through-hole 4c is not limited to the above. The through-hole 4c only needs to be located in a region including the axial direction center. Furthermore, the shape of the rotor 4 is not limited to the above. For example, the shape of the rotor 4 in the plan view may be a regular polygon such as a regular hexagon, a regular octagon, or a regular decagon in alternative aspects.

As illustrated in FIG. 2, the stator fixing member 6 is a flange in the present embodiment. The stator fixing member 6 has a main body portion 7 and a whirl-stop portion 8. In the plan view, the main body portion 7 has a circular shape and is disposed on the first main surface 3a side of the vibrating body 3. A first protruding portion 7a is provided in a central portion of the main body portion 7. The first protruding portion 7a extends in a direction orthogonal to a main surface of the main body portion 7. More specifically, the first protruding portion 7a protrudes to the inside of the case 5. It is also noted that the first protruding portion 7a may not necessarily be provided.

The whirl-stop portion 8 is connected to the first protruding portion 7a. The whirl-stop portion 8 extends from the first protruding portion 7a toward the vibrating body 3. In the present embodiment, the whirl-stop portion 8 is provided integrally with the first protruding portion 7a. The whirl-stop portion 8 is inserted through the through-hole 3c of the vibrating body 3. Note that the whirl-stop portion 8 is a portion that fixes the vibrating body 3 of the stator 2 and suppresses a rotation of the vibrating body 3.

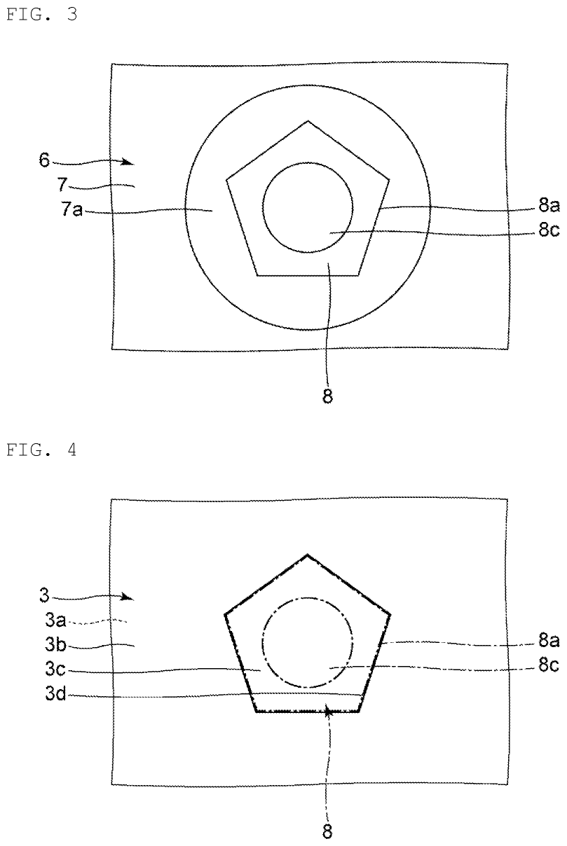

FIG. 3 is a plan view illustrating the vicinity of the whirl-stop portion and the first protruding portion of the stator fixing member according to the first embodiment. FIG. 4 is a plan view illustrating the through-hole of the vibrating body and the vicinity of the whirl-stop portion of the stator fixing member according to the first embodiment. Note that in FIG. 4, the whirl-stop portion 8 is indicated by a dashed-dotted line.

As illustrated in FIG. 3, the first protruding portion 7a has a circular shape in the plan view. More specifically, the first protruding portion 7a has a cylindrical shape that surrounds the whirl-stop portion 8 in the plan view. However, the shape of the first protruding portion 7a is not limited to the above.

As illustrated in FIG. 4, the whirl-stop portion 8 has a regular pentagonal shape in the plan view. Therefore, the number of vertices in the plan view of the polygonal shape of the whirl-stop portion 8 and the through-hole 3c of the stator 2 is the same. It is noted that the shape of the whirl-stop portion 8 in the plan view may be a polygon other than a pentagon according to the shape of the through-hole 3c. The whirl-stop portion 8 preferably has a regular polygonal shape in the plan view. Moreover, the whirl-stop portion 8 includes an outer side surface 8a that is in contact with the inner side surface 3d of the vibrating body 3 in the stator 2. More specifically, the whirl-stop portion 8 and the through-hole 3c are fitted to each other.

The whirl-stop portion 8 is provided with a through-hole 8c. In the plan view, the through-hole 8c has a circular shape. As illustrated in FIG. 1, one continuous through-hole is provided in the whirl-stop portion 8 and the first protruding portion 7a. The through-hole 8c is a part of the continuous through-hole. The shaft member 10 is inserted through the one continuous through-hole, the through-hole 3c of the stator 2, and the through-hole 4c of the rotor 4. Note that when viewed from a direction orthogonal to the axial direction Z, the through-hole 3c of the stator 2 overlaps with the through-hole 8c of the whirl-stop portion 8.

According to exemplary aspects, the material of the stator fixing member 6 can be, for example, a resin, a metal, or a ceramic. It is desirable that the stator fixing member 6 and the stator 2 be electrically insulated from each other.

According to the exemplary embodiment, the whirl-stop portion 8 and the through-hole 3c of the stator 2 have a polygonal shape in the plan view, the number of vertices of the whirl-stop portion 8 and the through-hole 3c is the same, and the whirl-stop portion 8 and the through-hole 3c are fitted to each other. Accordingly, the vibrating body 3 of the stator 2 can be effectively fixed. Furthermore, in the stator fixing member 6, since the vibrating body 3 is not firmly fixed at a portion other than the whirl-stop portion 8, the vibration of the vibrating body 3 is hardly inhibited.

Hereinafter, the configuration of the present embodiment will be described in more detail.

As illustrated in FIG. 1, the stator fixing member 6 has a second protruding portion 7b that protrudes from the main body portion 7 toward the outside of the case 5. The second protruding portion 7b has a cylindrical shape. One continuous through-hole is provided in the second protruding portion 7b, the first protruding portion 7a, and the whirl-stop portion 8. The inner diameter of the second protruding portion 7b is larger than the inner diameter of the first protruding portion 7a and the inner diameter of the whirl-stop portion 8. A first bearing portion 19A is provided in the second protruding portion 7b. The shaft member 10 is inserted through the first bearing portion 19A. The shaft member 10 passes through the first bearing portion 19A and protrudes to the outside of the case 5. It is noted that the second protruding portion 7b is not limited to a cylindrical shape, and may be any shape as long as the second protruding portion 7b has a tubular shape. Alternatively, the stator fixing member 6 may not necessarily be provided with the second protruding portion 7b. For example, the stator fixing member 6 may not necessarily be a first case member, and a first case member different from the stator fixing member 6 may be provided. However, since the stator fixing member 6 is a part of the case 5, the ultrasonic motor 1 can be downsized.

As further shown, the cap member 18 has a protruding portion 18a that protrudes to the outside of the case 5. In the exemplary aspect, the protruding portion 18a has a cylindrical shape. For the cap member 18, for example, a metal, a ceramic, or a resin can be used. In the present embodiment, the second case member of the case is the cap member 18. However, the second case member is not limited to the cap member 18. It is sufficient that a case in which the stator 2, the rotor 4, and the like are housed is configured.

A second bearing portion 19B is provided in the protruding portion 18a. The shaft member 10 is inserted through the second bearing portion 19B. The shaft member passes through the second bearing portion 19B and protrudes to the outside of the case 5.

The shaft member 10 is provided with a snap ring 17. The snap ring 17 has an annular shape. In the plan view, the snap ring 17 surrounds the shaft member 10. More specifically, an inner peripheral end edge portion of the snap ring 17 is located in the shaft member 10. The snap ring 17 is in contact with the first bearing portion 19A from the outside in the axial direction Z. As a result, a positional displacement of the shaft member 10 can be suppressed. In exemplary aspects, a material of the shaft member 10 and the snap ring 17 can be, for example, a metal or a resin. For the first bearing portion 19A and the second bearing portion 19B, for example, a sliding bearing, a bearing, or the like may be used.

The rotor 4 has a recess portion 4a and a side wall portion 4b. The recess portion 4a is circular in the plan view. The side wall portion 4b is a portion surrounding the recess portion 4a. The rotor 4 is in contact with the stator 2 on an end surface 4d of the side wall portion 4b. However, the recess portion 4a and the side wall portion 4b may not necessarily be provided. As a material of the rotor 4, for example, a metal or a ceramic can be used. In the present embodiment, the rotor 4 and the shaft member 10 are configured as separate bodies. However, the rotor 4 and the shaft member 10 may be integrally configured. That is, the rotor 4 may include the shaft member 10.

As further shown, an elastic member 12 is provided on the rotor 4. The elastic member 12 sandwiches the rotor 4 together with the stator 2 in the axial direction Z. The elastic member 12 has an annular shape. It is noted that the shape of the elastic member 12 is not limited to the above. In exemplary aspects, the material of the elastic member 12 can be, for example, a rubber or a resin. The elastic member 12 may not necessarily be provided in alternative aspects.

A spring member 16 is disposed on the second bearing portion 19B side of the rotor 4. More specifically, the spring member 16 of the present embodiment is a leaf spring made of a metal. A cavity 16c is provided in a central portion of the spring member 16. The shaft member 10 is inserted through the cavity 16c. The shaft member 10 has a wide portion 10a. The width of the wide portion 10a of the shaft member 10 is wider than the width of the other portion of the shaft member 10. Note that the width of the shaft member 10 is a dimension along a direction orthogonal to the axial direction Z of the shaft member 10. An inner peripheral end edge portion of the spring member 16 is in contact with the wide portion 10a. As a result, a positional displacement between the spring member 16 and the shaft member 10 can be suppressed. However, the material and configuration of the spring member 16 are not limited to the above. The configuration of the shaft member 10 is also not limited to the above.

An elastic force is applied from the spring member 16 to the rotor 4 via the elastic member 12. As a result, the rotor 4 is pressed against the stator 2. In this case, a frictional force between the stator 2 and the rotor 4 can be increased. Therefore, the traveling wave can be effectively propagated from the stator 2 to the rotor 4, and the rotor 4 can be efficiently rotated. Therefore, the ultrasonic motor 1 can be efficiently rotationally driven.

The rotor 4 may have a friction material fixed on its surface on the stator 2 side. Accordingly, the frictional force applied between the vibrating body 3 of the stator 2 and the rotor 4 can be stabilized. In this case, the rotor 4 can be efficiently rotated, and the ultrasonic motor 1 can be efficiently rotationally driven.

In addition, a plurality of protrusion portions 3e are provided on the second main surface 3b of the vibrating body 3. The plurality of protrusion portions 3e are portions of the vibrating body 3 in contact with the rotor 4. Each protrusion portion 3e protrudes in the axial direction Z from the second main surface 3b of the vibrating body 3. In the plan view, the plurality of protrusion portions 3e are arranged in an annular shape. Since the plurality of protrusion portions 3e protrude in the axial direction Z from the second main surface 3b, when the traveling wave is generated in the vibrating body 3, the tips of the plurality of protrusion portions 3e are displaced more largely. Therefore, the rotor 4 can be efficiently rotated by the traveling wave generated in the stator 2. Note that the plurality of protrusion portions 3e are not necessarily provided.

FIG. 5 is a bottom view of the stator according to the first exemplary embodiment.

As shown, a plurality of piezoelectric elements is provided on the first main surface 3a of the vibrating body 3. More specifically, the plurality of piezoelectric elements is a first piezoelectric element 13A, a second piezoelectric element 13B, a third piezoelectric element 13C, and a fourth piezoelectric element 13D. The plurality of piezoelectric elements is dispersedly disposed along a circumferential direction of a traveling wave so as to generate the traveling wave circulating around an axis parallel to the axial direction Z. When viewed from the axial direction Z, the first piezoelectric element 13A and the third piezoelectric element 13C face each other with the axis interposed therebetween. The second piezoelectric element 13B and the fourth piezoelectric element 13D face each other with the axis interposed therebetween.

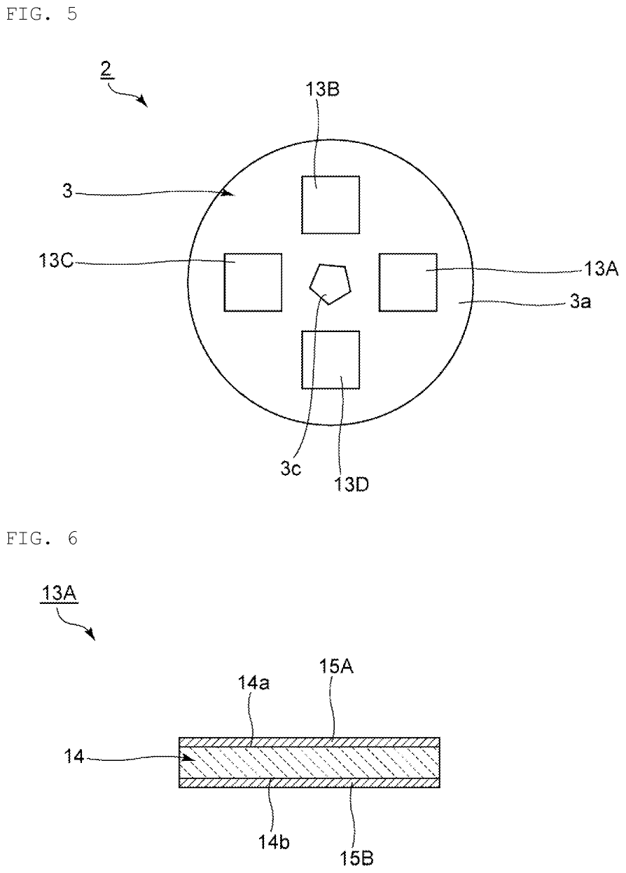

FIG. 6 is a front sectional view of the first piezoelectric element according to the first exemplary embodiment.

The first piezoelectric element 13A has a piezoelectric body 14 with a third main surface 14a and a fourth main surface 14b that face each other. The first piezoelectric element 13A has a first electrode 15A and a second electrode 15B. The first electrode 15A is provided on the third main surface 14a of the piezoelectric body 14, and the second electrode 15B is provided on the fourth main surface 14b of the piezoelectric body 14. The first electrode 15A and the second electrode 15B are electrodes for exciting the first piezoelectric element 13A. The second piezoelectric element 13B, the third piezoelectric element 13C, and the fourth piezoelectric element 13D are also configured similarly to the first piezoelectric element 13A. Each of the above piezoelectric elements has a rectangular shape in the plan view, but it is noted that the shape of each piezoelectric element in the plan view is not limited to the above, and may be, for example, a circle or an ellipse.

Here, the first electrode 15A is attached to the first main surface 3a of the vibrating body 3 with an adhesive. A thickness of this adhesive is very thin. Therefore, the first electrode 15A is electrically connected to the vibrating body 3.

In order to generate the traveling wave, the stator 2 only needs to have at least the first piezoelectric element 13A and the second piezoelectric element 13B. Alternatively, one piezoelectric element divided into a plurality of regions may be included. In this case, for example, each region of the piezoelectric element may be polarized in different directions. In the present description, one piezoelectric element and a plurality of piezoelectric elements having different polarization directions for each region may be referred to as a plurality of polarized piezoelectric elements. In the present embodiment, the plurality of polarized piezoelectric elements vibrates the vibrating body 3 in a vibration mode including nodal lines extending in a circumferential direction and a radial direction.

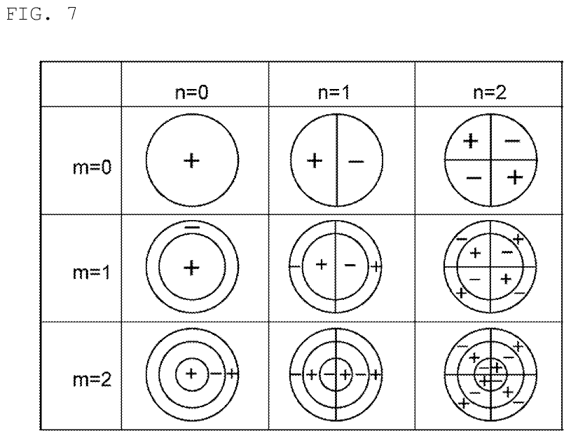

FIG. 7 is a schematic diagram for explaining each vibration mode. Specifically, FIG. 7 illustrates a phase of vibration in each region of the vibrating body 3 in the plan view. It is illustrated that regions denoted by a plus sign and regions denoted by a minus sign have phases of vibration opposite to each other.

When the number of the nodal lines extending in the circumferential direction is assumed to be m and the number of the nodal lines extending in the radial direction is assumed to be n, the vibration mode can be represented by a B (m, n) mode. In the present embodiment, the B (m, n) mode is used. That is, the number m of the nodal lines extending in the circumferential direction and the number n of the nodal lines extending in the radial direction may be 0 or any natural number.

In the stator 2, a structure in which a plurality of piezoelectric elements is dispersedly disposed in the circumferential direction and driven to generate a traveling wave is disclosed in, for example, WO 2010/061508 A1, the contents of which are hereby incorporated by reference. That is, the structure for generating the traveling wave is described in the following description, and thus a detailed description is omitted by incorporating the configuration described in WO 2010/061508 A1.

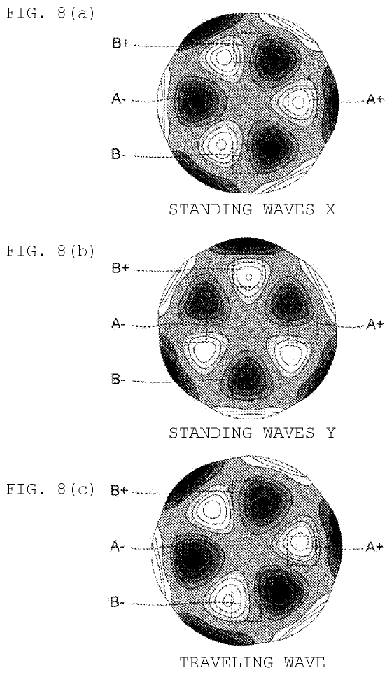

FIGS. 8(a) to 8(c) are schematic bottom views of the stator for explaining the traveling wave excited in the first embodiment. It is noted that FIGS. 8(a) to 8(c) indicate that, in a gray scale, the closer to black, the greater the stress in one direction, and the closer to white, the greater the stress in the other direction.

FIG. 8(a) illustrates three standing waves X, and FIG. 8(b) illustrates three standing waves Y. It is assumed that the first to the fourth piezoelectric elements 13A to 13D are disposed with a central angle of 90° therebetween. In this case, since the three standing waves X and Y are excited, the central angle with respect to a wavelength of the traveling wave is 120°. The central angle is determined by an angle 90° obtained by multiplying the angle 120° of one wave by ¾. The first piezoelectric element 13A is disposed at a predetermined place where an amplitude of the three standing waves X is large, and the second to the fourth piezoelectric elements 13B to 13D are disposed at intervals of the central angle of 90°. In this case, the three standing waves X and Y having phases of vibration different from each other by 90° are excited, and the three standing waves X and Y are combined to generate the traveling wave illustrated in FIG. 8(c).

It is also noted that in FIGS. 8(a) to 8(c), “A+”, “A−”, “B+”, and “B−” indicate polarization directions of the piezoelectric body 14. The sign “+” means that polarization is established from the third main surface 14a toward the fourth main surface 14b in a thickness direction. The sign “−” indicates that polarization is established in an opposite direction. “A” indicates the first piezoelectric element 13A and the third piezoelectric element 13C, and “B” indicates the second piezoelectric element 13B and the fourth piezoelectric element 13D.

It is noted that although an example of three waves has been described, the present invention is not limited thereto, and also in the case of six waves, nine waves, twelve waves, or the like, two standing waves having a phase difference of 90° are similarly excited, and a traveling wave is generated by combining the two standing waves. In the present invention, a configuration for generating a traveling wave is not limited to the configuration illustrated in FIGS. 8(a) to 8(c), and various conventionally known configurations for generating the traveling wave can be used.

Hereinafter, an example of an exemplary embodiment will be described. Returning to FIG. 3, as in the present embodiment, the main body portion 7 of the stator fixing member 6 preferably has the first protruding portion 7a. As a result, the stator 2 can be more reliably and stably disposed. The first protruding portion 7a preferably has a circular shape in the plan view. Accordingly, the stator 2 can be more reliably and stably disposed. Note that in the stator fixing member 6, since the stator 2 is firmly fixed at the whirl-stop portion 8, it is not necessary to firmly fix the stator 2 at the first protruding portion 7a. Therefore, if the first protruding portion 7a is provided, the vibration of the vibrating body 3 of the stator 2 is hardly inhibited.

Here, unlike the present embodiment, if the whirl-stop portion 8 is circular in the plan view, it is necessary to make a diameter of the first protruding portion 7a larger than a diameter of the whirl-stop portion 8 in order to support the stator 2 by the first protruding portion 7a. On the other hand, as in the present embodiment, if the whirl-stop portion 8 has a polygonal shape in the plan view as described above, for example, if a diameter of a circumscribed circle of the polygon is the same as a diameter of the first protruding portion 7a, the stator 2 can be supported by the first protruding portion 7a. Thus, the diameter of the first protruding portion 7a can be reduced. However, the diameter of the first protruding portion 7a may be larger than the diameter of the circumscribed circle of the polygon. Also in this case, the stator 2 can be suitably supported if the diameter of the first protruding portion 7a is reduced as compared with the case where the whirl-stop portion 8 is circular in the plan view. Therefore, the entire range of the portion supporting the stator 2 by the first protruding portion 7a can be brought close to the through-hole 3c of the stator 2. Therefore, the inhibition of the vibration of the stator 2 can be effectively suppressed, and a deterioration in the performance of the ultrasonic motor 1 can be effectively suppressed.

In the plan view, the whirl-stop portion 8 of the stator fixing member 6 and the through-hole 3c of the stator 2 preferably have a regular polygonal shape. Accordingly, a rotational driving stability of the ultrasonic motor 1 can be easily increased.

As described above, in the whirl-stop portion 8 and the through-hole 3c of the stator 2, the number of vertices of the polygonal shape in the plan view is the same. The number of vertices of the whirl-stop portion 8 and the number of vertices of the through-hole 3c are preferably five or seven in exemplary aspects. That is, the whirl-stop portion 8 and the through-hole 3c preferably have a pentagonal shape or a heptagonal shape in the plan view. Accordingly, the ultrasonic motor 1 can be downsized, and the vibrating body can be effectively fixed. The reason for this is as follows.

A diameter of an inscribed circle of the whirl-stop portion 8 in the plan view is based on the width of the shaft member 10 regardless of the number of vertices of the whirl-stop portion 8. On the other hand, a distance between the inscribed circle and the circumscribed circle of the whirl-stop portion 8 in the plan view increases as the number of vertices of the whirl-stop portion 8 decreases. If the diameter of the inscribed circle is constant and the distance between the inscribed circle and the circumscribed circle is long, the diameter of the circumscribed circle increases. In this case, it is necessary to increase a diameter of the through-hole 3c of the stator 2. Here, if the number of vertices of the whirl-stop portion 8 is five or more, the distance between the inscribed circle and the circumscribed circle can be sufficiently shortened, and the diameter of the circumscribed circle can be reduced. Therefore, the diameter of the through-hole 3c can be reduced, and the stator 2 can be downsized. Therefore, the ultrasonic motor 1 can be downsized.

On the other hand, if the number of vertices of the whirl-stop portion 8 is too large, the shape of the whirl-stop portion 8 in the plan view approaches a circular shape. If the number of vertices of the whirl-stop portion 8 is seven or less, the resistance of the stator 2 to the rotation of the vibrating body 3 can be effectively increased, and the vibrating body 3 can be effectively fixed.

As described above, the vibrating body 3 of the stator 2 vibrates in the B (m, n) mode. In the vibration of the vibrating body 3, the number of the nodal lines extending in the radial direction is n. When the number of vertices of the polygonal shape in a plan view of the whirl-stop portion 8 and the through-hole 3c of the stator 2 is a, a≠n is preferably satisfied. As a result, it is possible to suppress a standing wave from being superimposed on the traveling wave. Therefore, the generation of a ripple in the traveling wave can be suppressed. Therefore, the deterioration in the performance of the ultrasonic motor 1 can also be suppressed. However, it is noted that the relationship between the number a and the number n is not limited to the above.

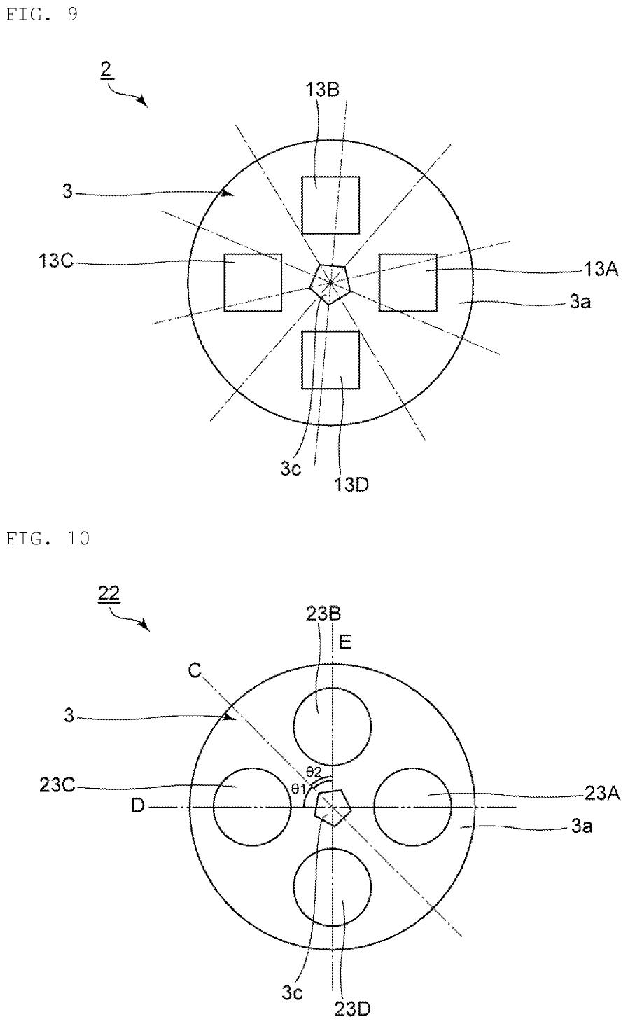

FIG. 9 is a bottom view for explaining the relationship between the shape of the through-hole and the position of the piezoelectric element in the stator of the first exemplary embodiment.

A dashed-dotted line in FIG. 9 indicates a straight line connecting a vertex of the through-hole 3c of the vibrating body 3 in the stator 2 and a center of the through-hole 3c. Each of the five straight lines illustrated in FIG. 9 passes through one of the plurality of vertices of the through-hole 3c. Each straight line does not pass through a center of each piezoelectric element in the plan view. Here, as illustrated in FIG. 6, in the present embodiment, the first electrode 15A is provided on the entire third main surface 14a of the piezoelectric body 14. Similarly, the second electrode 15B is provided on the entire surface of the fourth main surface 14b. Therefore, a center of the first electrode 15A and a center of the second electrode 15B of each piezoelectric element are not located on each straight line illustrated in FIG. 9. It is noted that as described above, the first electrode 15A and the second electrode 15B are excitation electrodes.

Since the through-hole 3c of the stator 2 has a non-circular shape in the plan view, the through-hole 3c has an asymmetry in a circumferential direction. The arrangement of the first electrode 15A and the second electrode 15B of the plurality of piezoelectric elements also has an asymmetry in the circumferential direction. As described above, the centers of the first electrode 15A and the second electrode 15B of each piezoelectric element are preferably not located on a straight line connecting the vertex of the through-hole 3c and the center of the through-hole 3c in the plan view. Accordingly, the degree of coincidence between the asymmetry of the through-hole 3c in the circumferential direction and the asymmetry of the first electrode 15A and the second electrode 15B of the plurality of piezoelectric elements can be reduced. As a result, a standing wave can be prevented from overlapping the traveling wave, and the generation of the ripple in the traveling wave can be suppressed. Therefore, the deterioration in the performance of the ultrasonic motor 1 can also be suppressed. However, the arrangement of the first electrode 15A and the second electrode 15B of each piezoelectric element is not limited to the above.

It is also noted that if an excitation electrode and another electrode are provided on the piezoelectric body 14, a center of the excitation electrode is preferably not located on each straight line illustrated in FIG. 9. If one piezoelectric element having a polarization direction different for each region is used, the center of each excitation electrode is preferably not located on a straight line connecting the center of the through-hole of the stator and the vertex of the through-hole.

Meanwhile, the main body portion 7 and the whirl-stop portion 8 of the stator fixing member 6 may be made of different materials. At least the whirl-stop portion 8 is preferably made of a resin. Accordingly, the whirl-stop portion 8 hardly affects the vibration of the stator 2. Therefore, the accuracy of the rotation angle can be increased. If the whirl-stop portion 8 is made of a resin and the main body portion 7 is made of a metal, a ceramic, or the like, for example, the stator fixing member 6 may be formed by insert molding or the like. Alternatively, the whirl-stop portion 8 and the main body portion 7 may be joined after the whirl-stop portion 8 and the main body portion 7 are separately formed.

FIG. 10 is a bottom view for explaining the relationship between the shape of the through-hole and the position of the piezoelectric element in the stator of the second exemplary embodiment.

It should be that this embodiment is different from the first embodiment in that a first piezoelectric element 23A, a second piezoelectric element 23B, a third piezoelectric element 23C, and a fourth piezoelectric element 23D have a circular shape in the plan view. Furthermore, the relationship between the shape of the through-hole 3c of the vibrating body 3 in a stator 22 and the arrangement of the plurality of piezoelectric elements is different from that of the first embodiment. Other than the above points, the ultrasonic motor of the second exemplary embodiment has a configuration similar to that of the ultrasonic motor 1 of the first embodiment.

A dashed-dotted line in FIG. 10 is a straight line C connecting one of the vertices of the through-hole 3c of the vibrating body 3 in the stator 22 and the center of the through-hole 3c. More specifically, the straight line C passes between the first piezoelectric element 23A and the fourth piezoelectric element 23D and between the second piezoelectric element 23B and the third piezoelectric element 23C. Although not illustrated except for the straight line C, the center of the excitation electrode of each piezoelectric element in the stator 22 is not located on a straight line connecting the center of the through-hole 3c and the vertex of the through-hole 3c.

Moreover, two dashed-dotted lines in FIG. 10 are a straight line D and a straight line E connecting the centers of the electrodes of two piezoelectric elements facing each other with the through-hole 3c interposed therebetween. More specifically, the straight line connecting the centers of the excitation electrodes in the first piezoelectric element 23A and the third piezoelectric element 23C is the straight line D. The straight line connecting the centers of the excitation electrodes in the second piezoelectric element 23B and the fourth piezoelectric element 23D is the straight line E. In the present embodiment, the center of the through-hole 3c is located on the straight line D and the straight line E. The straight line D and the straight line E are orthogonal to each other.

An angle θ1 formed by the straight line C and the straight line D is 45°. Similarly, an angle θ2 formed by the straight line C and the straight line E is also 45°. When the straight line C is a symmetry axis, the first piezoelectric element 23A and the second piezoelectric element 23B, and the third piezoelectric element 23C and the fourth piezoelectric element 23D are disposed line-symmetrically. Accordingly, since the ripple in the traveling wave is canceled, the ripple can be further suppressed. Therefore, the deterioration in the performance of the ultrasonic motor can be further suppressed.

In the present embodiment, the stator fixing member 6 is configured similarly to the first embodiment illustrated in FIG. 1 and the like. Therefore, similarly to the first embodiment, the whirl-stop portion 8 and the through-hole 3c of the vibrating body 3 have a polygonal shape in the plan view, the number of vertices of the whirl-stop portion 8 and the through-hole 3c is the same, and the whirl-stop portion 8 and the through-hole 3c are fitted to each other. Accordingly, the vibrating body 3 of the stator 2 can be effectively fixed, and the vibration of the vibrating body 3 is hardly inhibited.

In general, it is noted that each of the exemplary embodiments described herein is illustrative and that partial substitutions or combinations of configurations are possible among different embodiments as would be appreciated to one skilled in the art. While exemplary embodiments of the present invention have been described above, it is to be understood that variations and modifications will be apparent to those skilled in the art without departing from the scope and spirit of the present invention.

### DESCRIPTION OF REFERENCE SYMBOLS

1: Ultrasonic motor
2: Stator
3: Vibrating body
3a, 3b: First and second main surfaces
3c: Through-hole
3d: Inner side surface
3e: Protrusion portion
4: Rotor
4a: Recess portion
4b: Side wall portion
4c: Through-hole
4d: End surface
5: Case
6: Stator fixing member
7: Main body portion
7a, 7b: First and second protruding portions
8: Whirl-stop portion
8a: Outer side surface
8c: Through-hole
Shaft member
Wide portion
12: Elastic member
13A to 13D: First to fourth piezoelectric elements
14: Piezoelectric body
14a, 14b: Third and fourth main surfaces
15B: First and second electrodes
16: Spring member
16c: Cavity
17: Snap ring
18: Cap member
18a: Protruding portion
19A, 19B: First and second bearing portions
22: Stator
23A to 23D: First to fourth piezoelectric elements

1. An ultrasonic motor comprising:
a stator having a plate-shaped vibrating body including a first main surface and a second main surface that oppose each other, a through-hole that penetrates in a direction normal to the first and second main surfaces, and at least one piezoelectric element on the first main surface of the vibrating body;
a rotor coupled to the second main surface of the vibrating body; and
a stator fixing member having a main body on the first main surface of the vibrating body and a whirl-stop portion that extends from the main body toward the vibrating body,
wherein the whirl-stop portion and the through-hole have a polygonal shape in a plan view, the whirl-stop portion has a same number of vertices as the through-hole, and the whirl-stop portion is fitted to the through-hole.

2. The ultrasonic motor according to claim 1, wherein the main body of the stator fixing member has a protruding portion that protrudes toward the vibrating body.

3. The ultrasonic motor according to claim 2, wherein the whirl-stop portion is connected to the protruding portion, and the protruding portion surrounds the whirl-stop portion in the plan view.

4. The ultrasonic motor according to claim 3, wherein the protruding portion has a circular shape in the plan view.

5. The ultrasonic motor according to claim 1, wherein the vibrating body has a disk shape and is configured to vibrates in a B (m, n) mode, and a number of nodal lines extending in a radial direction in vibration of the vibrating body is n.

6. The ultrasonic motor according to claim 5, wherein a≠n is satisfied when the number of vertices of a polygonal shape in the plan view of the whirl-stop portion of the stator fixing member and the through-hole of the stator is a.

7. The ultrasonic motor according to claim 1, wherein the at least one piezoelectric element has a piezoelectric body and an excitation electrode on the piezoelectric body.

8. The ultrasonic motor according to claim 7, wherein a center of the excitation electrode of the at least one piezoelectric element is not located on a straight line connecting a vertex of the through-hole of the stator and a center of the through-hole in the plan view.

9. The ultrasonic motor according to claim 1, wherein each of the whirl-stop portion of the stator fixing member and the through-hole of the stator have a regular polygon shape in the plan view.

10. The ultrasonic motor according to claim 1, wherein the number of vertices of the whirl-stop portion of the stator fixing member and the number of vertices of the through-hole of the stator are five or seven.

11. The ultrasonic motor according to claim 1, wherein the at least one piezoelectric element comprises a plurality of piezoelectric elements on the first main surface of the vibrating body that are dispersedly disposed along a circumferential direction of a traveling wave.

12. The ultrasonic motor according to claim 1, further comprising a shaft member that extends through the through-hole of the stator.

13. The ultrasonic motor according to claim 12, further comprising a spring member on a bearing portion side of the rotor.

14. The ultrasonic motor according to claim 13, wherein an inner peripheral end edge of the spring member is coupled to a wide portion of the shaft member.

15. The ultrasonic motor according to claim 3, wherein the whirl-stop portion extends from the protruding portion towards the vibrating body.

16. The ultrasonic motor according to claim 15, wherein the whirl-stop portion is provided integrally with the protruding portion.

17. The ultrasonic motor according to claim 1, wherein the whirl-stop portion is configured to fix the vibrating body of the stator and suppress a rotation of the vibrating body.

18. An ultrasonic motor comprising:
a stator having a vibrating body with first and second main surface that oppose each other, a through-hole that extends in a direction normal to the first and second main surfaces, and at least one piezoelectric element on the first main surface of the vibrating body;
a rotor coupled to the second main surface of the vibrating body; and
a stator fixing member having a main body on the first main surface of the vibrating body and a whirl-stop portion that extends from the main body toward the vibrating body,
wherein the whirl-stop portion is fitted to the through-hole and is configured to fix the vibrating body of the stator and suppress a rotation of the vibrating body.

19. The ultrasonic motor according to claim 1, wherein the whirl-stop portion and the through-hole have a polygonal shape in a plan view and the whirl-stop portion has a same number of vertices as the through-hole.

20. The ultrasonic motor according to claim 18,
wherein the main body of the stator fixing member has a protruding portion that protrudes toward the vibrating body side, and
wherein the whirl-stop portion is connected to the protruding portion, and the protruding portion surrounds the whirl-stop portion in the plan view.
